(19) United States
(12) Patent Application Publication
(10) Pub. No.: US 2025/0227646 A1
(43) Pub. Date: Jul. 10, 2025

(54) METHOD AND SYSTEM FOR INTELLIGENT DATA COLLECTION AND MANAGEMENT FOR OPEN RAN INTELLIGENT CONTROLLERS

(71) Applicant: NEC Laboratories Europe GmbH, Heidelberg (DE)

(72) Inventors: Linghang FAN, Heidelberg (DE); Xi LI, Heidelberg (DE); Andres GARCIA-SAAVEDRA, Heidelberg (DE)

(21) Appl. No.: 18/854,559

(22) PCT Filed: Aug. 11, 2023
(86) PCT No.: PCT/EP2023/072346

§ 371 Date: Oct. 7, 2024

(30) Foreign Application Priority Data
Aug. 12, 2022 (EP) 22190312

(51) Int. Cl. H04W 60/04; H04W 48/08; H04W 48/16

(52) U.S. Cl. CPC H04W 60/04; H04W 48/08; H04W 48/16

(57) ABSTRACT

A method of operating an open radio access network (O-RAN) is provided. The O-RAN includes a Non-Real-Time RAN Intelligent Controller (Non-RT RIC) and a Near-Real-Time RAN Intelligent Controller (Near-RT RIC). An interface provided between the Non-RT RIC and the Near-RT RIC is used to send analytical data from the Near-RT RIC to the Non-RT RIC.

### CROSS REFERENCE TO RELATED APPLICATIONS

This application is a U.S. National Phase application under 35 U.S.C. § 371 of International Application No. PCT/EP2023/072346, filed on Aug. 11, 2023, and claims benefit to European Patent Application No. EP 22190312, filed on Aug. 12, 2022. The International Application was published in English on Feb. 15, 2024 as WO 2024/033545 A1 under PCT Article 21(2).

### FIELD

The present disclosure relates to a communication method and system. The disclosure has particular but not exclusive relevance to wireless communication systems and devices thereof operating according to the 3rd Generation Partnership Project (3GPP) standards or equivalents or derivatives thereof. The disclosure has particular although not exclusive relevance to the so-called ‘5G’ (or ‘Next Generation’) systems using intelligent data collection/management. More specifically, the present disclosure relates to a method of operating an open radio access network, O-RAN, the O-RAN comprising a Non-Real-Time RAN Intelligent Controller, Non-RT RIC, and a Near-Real-Time RAN Intelligent Controller, Near-RT RIC.

### BACKGROUND

Embodiments of the present invention are based on open Radio Access Networks (O-RAN). O-RAN provides a technical concept designed to improve interoperability in the RANs of mobile networks. By defining standards for open interfaces and by providing network elements abstracted from hardware, O-RAN creates radio access networks that are independent of proprietary technology.

As shown in FIG. 1, the novel O-RAN architecture for next-generation mobile systems defines a computing platform known as O-Cloud 110 to offload signal processing workload from virtualized BSs. An O-Cloud 110 provides signal processors comprised of software processing devices 112 (e.g., general-purpose CPUs) and HAs 114 such as FPGAs, GPUs or ASICs. Each processor queues FEC processing requests in a first-in-first-out (FIFO) queue and, once processed, the resulting TB data is sent back to the associated BS.

FIG. 1 illustrates a high-level view of the O-RAN architecture, wherein only an O-DU (O-RAN Distributed Node) network node 116 is shown for simplicity. As shown, the O-RAN architecture consists of the network functions (e.g. O-DUs 116) controlled by the Near-Real-Time (Near-RT) RAN Intelligent Controller (RIC) 118 through E2 interface 120, a Service Management and Orchestration framework (SMO) 122 to manage the network functions and the O-Cloud 110 (O-RAN Cloud) to host the cloudified network functions. SMO 122 includes the Non-Real-Time (NON-RT) RAN Intelligent Controller (RIC) 124 as a central component, enabling non-real-time control and optimization of RAN elements and resources.

In O-RAN, BSs (i.e. O-DUs 116, to be more specific) are controlled by a near-real-time RAN intelligent controller (Near-RT RIC) 118 using applications. These applications are known as xApps and operate in the timescale of ˜10-100 ms (i.e., 10 or 100 times longer than a TTI). A data-driven policy is deployed in a Near-RT RIC 118 and E2 interface 120 may be used to control an offloading strategy of BSs deployed over a prototype O-Cloud 110 platform. Common 3GPP Radio Resource Management (RRM) operations, for instance, are performed through this interface. Conversely, O2 interface 126 is used to provide two services: infrastructure management services (deployment and management of O-Cloud 110 infrastructure), and deployment management services (lifecycle management of virtualized deployments on O-Cloud 110 infrastructure).

The ORAN Working Group 2 are currently defining the Non-RT RIC architecture [2], R1 interface [3] and A1 interface [4], and the ORAN Working Group 3 are currently defining the Near-RT RIC architecture [5], and E2 interface [6].

In the current ORAN design, the applications in the Non-RT RIC can only obtain raw data from the base stations via the defined O1 interface. With the latest ORAN design and specifications, the Non-RT RIC can provide analytical information in the form of enrichment information to near-RT RIC, but it cannot access and acquire analytical data from the Near-RT RIC [2][3] on the other direction, let alone efficiently utilizing the analytical data generated by the Near-RT RIC. This wastes the network resources of mobile operator infrastructures since large volumes of raw data need to be transported via the O1 interface, even though some related analytical data may be available in the Near-RT RIC. This leads to multiple drawbacks on both the networks and the performances of the applications: It not only causes redundant data collection, but also may cause a delay on data collection and processing. Especially some analytical data needs to be processed or to be trained by selected analytical tools or ML models and in turn requiring additional training time.

### SUMMARY

In an embodiment, the present disclosure provides a method of operating an open radio access network (O-RAN). The O-RAN includes a Non-Real-Time RAN Intelligent Controller (Non-RT RIC) and a Near-Real-Time RAN Intelligent Controller (Near-RT RIC). An interface provided between the Non-RT RIC and the Near-RT RIC is used to send analytical data from the Near-RT RIC to the Non-RT RIC.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a block diagram schematically illustrating an overview of the general O-RAN architecture according to prior art;

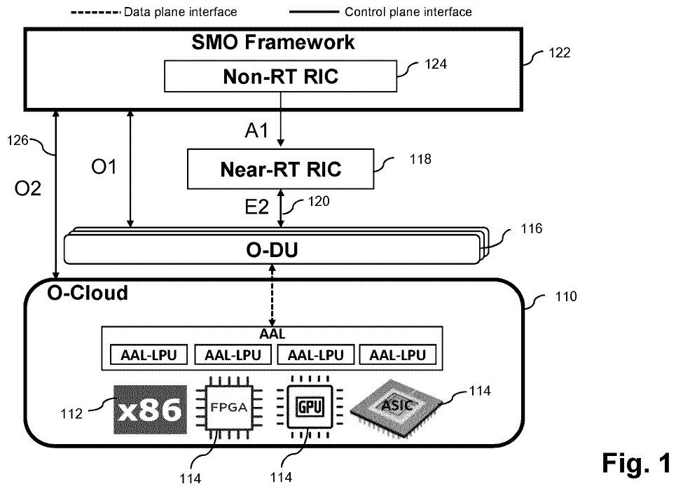

FIG. 2 is a block diagram schematically illustrating an O-RAN architecture with a new interface between the Non-RT RIC and the Near-RT RIC according to an embodiment of the present disclosure;

FIG. 3 is a diagram illustrating a data registration procedure according to an embodiment of the present disclosure;

FIG. 4 is a diagram illustrating a data discovery procedure for rApps in a Non-RT RIC according to an embodiment of the present disclosure;

FIG. 5 is a diagram illustrating a data subscription procedure for rApps in a Non-RT RIC according to an embodiment of the present disclosure;

FIG. 6 is a diagram illustrating a data request procedure for rApps in a Non-RT RIC according to an embodiment of the present disclosure;

FIG. 7 is a diagram schematically illustrating an O-RAN architecture, to which aspects of the present disclosure are applicable according to an embodiment of the present disclosure;

FIG. 8 is a block diagram schematically illustrating the main components of a UE that communicates with the system shown in FIG. 7 according to an embodiment of the present disclosure;

FIG. 9 is a block diagram schematically illustrating the main virtual components of a v(R)AN used in the system shown in FIG. 7 according to an embodiment of the present disclosure; and

FIG. 10 is a block diagram schematically illustrating the main virtual components of a generic core network node (or function) used in the system shown in FIG. 7 according to an embodiment of the present disclosure.

### DETAILED DESCRIPTION

The following abbreviations and terminology (unless otherwise indicated) are used in the present document:
3GPP 3rd Generation Partnership Project
A1 Interface between Non-RT RIC and Near-RT RIC
AI Artificial Intelligence
DME Data management and exposure
DMS Deployment Management Services
E2 Interface between Near-RT RIC and underlying RAN functions (O-CU, O-DU and O-RU)
EI Enrichment Information
KPI Key performance indicator
ML Machine Learning
Near-RT RIC O-RAN Near-Real-Time RAN Intelligent Controller
Non-RT RIC O-RAN Non-Real-Time RAN Intelligent Controller
O-CU O-RAN Central Unit
O-DU O-RAN Distributed Unit
O-RU O-RAN Radio Unit
O1 Interface between SMO and O-RAN managed elements
OAM Operations, Administration and Maintenance
RAN Radio Access Network
RIC O-RAN RAN Intelligent Controller
rApp Non-RT RIC Applications
SMO Service Management and Orchestration
UE User Equipment
xApp Near-RT RIC Applications

Furthermore, the present disclosure makes reference to the following documents, which are hereby incorporated herein by reference:
[1] 3GPP TR 21.905: “Vocabulary for 3GPP Specifications”. V17.0.0 (2020 July)
[2] O-RAN WG2: “Non-RT RIC Functional Architecture Specification”, V01.00.05 (2022 March)
[3] O-RAN WG2: “R1 interface: General Aspects and Principles”, V01.00.12 (2022 March )
[4] O-RAN WG2: “A1 interface: General Aspects and Principles”, V02.02 (2021 March)
[5] O-RAN WG3: “Near-RT RIC Architecture”, V02.01.04 (2021 November)
[6] O-RAN WG3: “Near-Real-time RAN Intelligent Controller Architecture & E2 General Aspects and Principles”, V02.02.01 (2022 March)
[7] A. Garcia-Saavedra and X. Costa-Pérez, “O-RAN: Disrupting the Virtualized RAN Ecosystem,” in IEEE Communications Standards Magazine, vol. 5, no. 4, pp. 96-103, December 2021, doi: 10.1109/MCOMSTD.101.2000014.

In accordance with an embodiment, the present disclosure improves and further develops an open radio access network, O-RAN, and a method of operating in such a way that available information can be used more efficiently and intelligently.

In accordance with an embodiment, the present embodiment provides a method of operating an open radio access network, O-RAN, the O-RAN comprising a Non-Real-Time RAN Intelligent Controller, Non-RT RIC, and a Near-Real-Time RAN Intelligent Controller, Near-RT RIC, the method comprising providing an interface between the Non-RT RIC and the Near-RT RIC, and using the interface to send analytical data from the Near-RT RIC to the Non-RT RIC.

Furthermore, in accordance with another embodiment, the present disclosure provides an open radio access network, O-RAN, system, the O-RAN system comprising a Non-Real-Time RAN Intelligent Controller, Non-RT RIC, a Near-Real-Time RAN Intelligent Controller, Near-RT RIC, and an interface between the Non-RT RIC and the Near-RT RIC, wherein the interface is configured to enable sending analytical data from the Near-RT RIC to the Non-RT RIC.

In order to address and solve the above problems caused by the current inefficient data collection mechanism, the present disclosure provides Intelligent Data Collection via Data Management and Exposure (DME) solutions to provide Non-RT RICs the data, including analytical data, generated from the Near-RT RIC. More specifically, embodiments of the present disclosure solve the following problems, which have not been addressed in ORAN:
How can the Non-RT RIC find the analytical data generated by the Near-RT RIC?
How can the Non-RT RIC access and obtain the analytical data generated by the Near-RT RIC?
What type of the data information are relevant for the Non-RT RIC?
What new parameters are needed to improve the efficiency of data collection? How to use these new parameters?
How can the Non-RT RIC efficiently use the analytical data generated by the Near-RT RIC?

Embodiments of the present disclosure provide a new method, including a new interface and a suite of procedures for the O-RAN Non-Real-Time RAN Intelligent Controller (Non-RT RIC) to collect analytical data. A set of new parameters are suggested alongside to be used in these procedures to enable the Non-RT RIC to acquire the data more efficiently while optimizing the operator network resource utilization and reducing overall data collection, inference and training time.

Currently, there is an one-directional A1 interface that enables the Near-RT RIC to obtain analytical data from the Non-RT RIC. The purpose of the new interface according to the present disclosure is to enable the rApps in the Non-RT RIC to obtain analytical data provided by the xApps in the Near-RT RIC. According to an embodiment, the new interface may be implemented as a bidirectional enhancement of the current defined unidirectional A1-EI interface. According to an alternative or additional embodiment, the new interface may be implemented as a complete new interface—either one-directional or bidirectional—to enable providing the analytical data from near-RT RIC to Non-RT RIC.

By definition of a new interface and a suite of data collection and management related procedures, including data registration procedure, data discovery procedure, data subscription procedure and data request procedure, the applications (e.g., rApps) in the Non-RT RIC are enabled to discover and obtain analytical data from the Near-RT RIC (provided by the xApps) or possibly also from the Non-RT RIC (provided by the rApps).

In the context of the present disclosure, the term ‘analytical data’ is to be understood in a broad sense and may generally include all kind of data that is produced in the Near-RT RIC and that may be required by the Non-RT RIC, and vice versa. For example, considering, e.g., a Massive MIMO (Multiple Input Multiple Output) use case, xApps in the Near-RT RIC can produce analytics data on UE trajectory prediction, cell coverage prediction, cell load prediction and traffic prediction based on the collected raw data. An rApp in the Non-RT RIC, whose main functionality is to optimize the beamforming of massive MIMO, can utilize these analytical data from xApps for beam management optimization, instead of training its AI/ML model based on raw data only. As such, the provision of analytical data according to embodiments disclosed herein reduces duplicated data collection, decreases the load on O1, and improves the efficiency of AI/ML model training.

In accordance with embodiments of the present disclosure, new parameters (i.e. data sources, Output Data Function ID, and Methods Used) are defined to specify data sources, output data type, and the used methods, in order to improve the efficiency of data collection in terms of saving network resources, reducing overall data collection time and training time. These new parameters may not only be used in the procedures/messages from Near-RT RIC to Non-RT RIC, but can also be used in the current procedures/messages from Non-RT RIC to Near-RT RIC to bring the efficiency in the data collection.

Currently, in ORAN design, Non-RT RIC can provide analytical information in the form of enrichment information to near-RT RIC, but cannot collect analytical data from the Near-RT RIC. Embodiments of the present disclosure provide a new interface and a suite of data management related procedures, namely data registration procedure, data discovery procedure, data subscription procedure and data request procedure, to enable applications in the Non-RT RIC to discover and obtained the analytical data from Near-RT RIC. In this way, the analytical data generated by the applications in the Near-RT RIC can be used by the applications in the Non-RT RIC, and therefore provides a significant large choice of data and reduce the amount of data collection.

Currently, i.e. in current O-RAN systems as described in references [2]-[6], the purpose of data collection is to obtain the data that exists in the databases, hence, data cannot be used intelligently. Embodiments of the present disclosure provide to use a number of parameters, such as Methods Used Output Data Function ID and Methods Used, to enable applications to undertake data analysis based on data from different data sources and different methods, and therefore to efficiently and intelligently use the data.

It is noted that there are many non-RT RIC use cases and applications that can also benefit from getting the analytical data directly from the near-RT RIC, such as vrAIn as described in [7]. vrAIn may require contextual information from all base stations deployed in the O-Cloud. This information includes mean and variance SNR across all UEs within each base station, and the aggregated buffer states within a time period. By aggregating and analysing this information at the near-RT-RIC, vrAIn saves substantial bandwidth in O1 interface.

According to an embodiment of the present disclosure, a new interface is provided between Non-RT RIC and Near-RT RIC to send analytical data from near-RT RIC to non-RT RIC. This interface may be used by xApps to register its produced data to the Non-RT RIC with a number of data related parameters. The interface may likewise be used by rApps to discover data produced by xApps in the Near-RT RIC with a number of data related parameters, by rApps to subscribe data produced by xApps in the Near-RT RIC with a number of data related parameters, an or by rApps to request data produced by xApps in the Near-RT RIC with a number of data related parameters.

According to an embodiment of the present disclosure, a data registration procedure may be executed that allows xApps in Near-RT RIC to register the data that it provides to the Non-RT RIC with a number of data related parameters to facilitate intelligent usage of data (xApps->DME in Non-RT RIC). In this context, it may be provided that the xApps have registered their generated data at Non-RT RIC via the novel interface between the Non-RT RIC and Near-RT RIC.

According to an embodiment of the present disclosure, a data discovery procedure may be executed that allows rApps in Non-RT RIC to discover the data provided at the Non-RT RIC with a number of data related parameters to facilitate intelligent usage of data (rApps->DME in Non-RT RIC). In this context, it may be provided that the rApps request to discover the data from functions who register/manage data in the Non-RT RIC. The functions that register/manage data in the Non-RT RIC may respond with the information related to the data.

According to an embodiment of the present disclosure, a data subscription procedure may be executed that allows rApps in Non-RT RIC to subscribe to the data provided by the xApps in the near-RT RIC with a number of data related parameters to facilitate intelligent usage of data (rApps->DME in Non-RT RIC). In this context, it may be provided that the rApps request to subscribe the data from functions that register/manage data in the Non-RT RIC. The functions who register/manage data in the Non-RT RIC may subscribe the data via the interface between Non-RT TRIC and Near-RT RIC. The Near-RT RIC may respond with information on how to collect the data.

According to an embodiment of the present disclosure, a data request procedure may be executed that allows rApps in the Non-RT RIC to request the data provided by the xApps in the near-RT RIC with a number of data related parameters to facilitate intelligent usage of data (rApps->DME in Non-RT RIC). In this context, it may be provided that the rApps request to request the data from functions that register/manage data in the Non-RT RIC. The functions that register/manage data in the Non-RT RIC may subscribe the data via the interface between Non-RT TRIC and Near-RT RIC. The Near-RT RIC may respond with information on how to collect the data.

According to the above embodiments, the present disclosure provides two different ways to obtain analytical data from the Near-RT RIC. One is data subscription and one is data request. In data subscription, an xApp provides the data to an rApp as long as the subscription is valid. The xApp will stop to provide data to the rApp only when the rApp terminates the subscription. On the other hand, in data request, an xApp provides the data to an rApp once, i.e. in a one-time operation upon request. It will be understood that an rApp can utilize both options in parallel/concurrently.

There are several ways how to design and further develop the teaching of the present invention in an advantageous way. To this end, it is to be referred to the dependent claims on the one hand and to the following explanation of preferred embodiments of the invention by way of example, illustrated by the figure on the other hand. In connection with the explanation of the preferred embodiments of the invention by the aid of the figure, generally preferred embodiments and further developments of the teaching will be explained. In the drawing

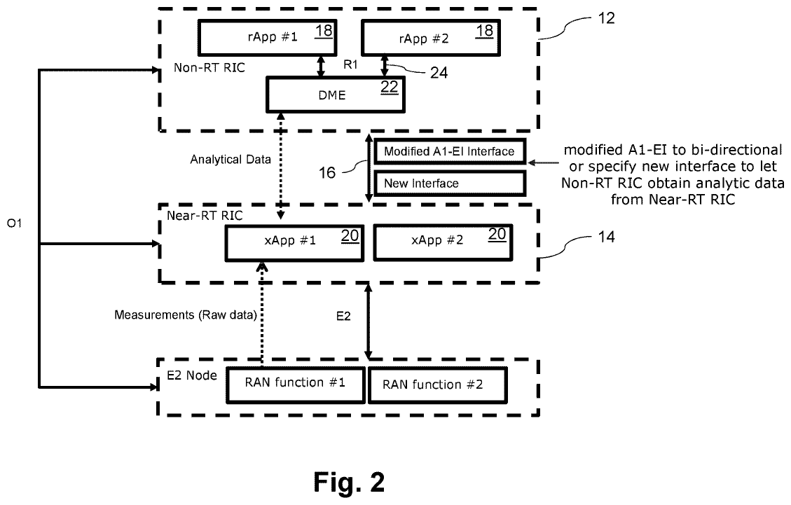

Currently, in ORAN design, the Non-RT RIC can provide analytical information in the form of enrichment information to the Near-RT RIC, but cannot collect analytical data from the Near-RT RIC. According to an embodiment, the present disclosure provides an O-RAN architecture including a novel interface between the Non-RT RIC 12 and the Near-RT RIC 14. As illustrated in the exemplary architecture shown in FIG. 2, the new interface 16 may be configured to send analytical data from the Near-RT RIC 14 to the Non-RT RIC 12. In particular, it may be provided that the new interface 16 enables the rApps 18 in the Non-RT RIC 12 to obtain the analytical data provided by the xApps 20 in the Near-RT RIC 14. As shown in FIG. 2, the new interface 16 can be realized by either enhancing the currently defined unidirectional A1-EI interface into bi-directional, or it can be specified as a completely new interface to enable providing the analytical data from the Near-RT RIC 14 to the Non-RT RIC 12. This design provides significant implementation flexibility.

As will be appreciated by those skilled in the art, different names can be used for the above design, in particular for the new interface, while serving the same and similar purposes.

According to another aspect of the present disclosure, a data registration procedure may be implemented that allows xApps 20 in Near-RT RIC 14 to register the data that they provide to the Non-RT RIC 12 with new parameters to facilitate intelligent usage of data. A main idea of data registration procedure is that an xApp 20 sends a data registration request to the Non-RT RIC 12 to register the data that it will produce. According to an embodiment, an xApp 20 may register the data it provides to the DME 22 in Non-RT RIC 12.

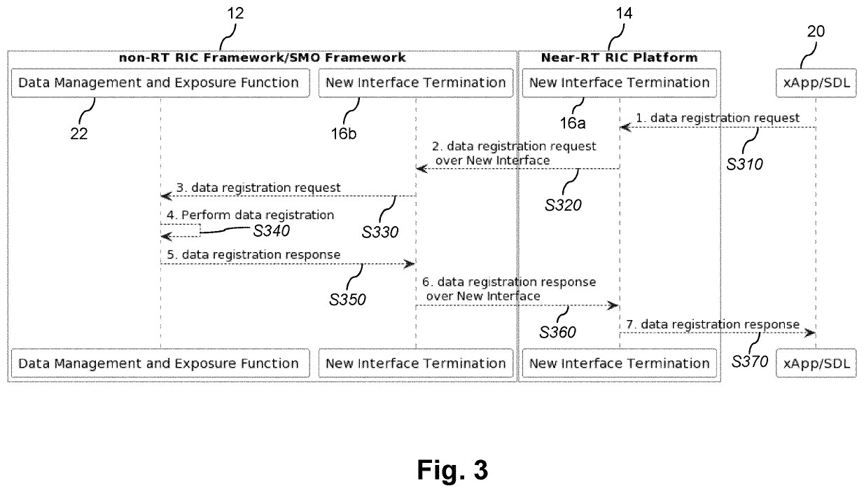

FIG. 3 is a diagram illustrating a data registration procedure according to an embodiment of the present disclosure. The procedure focuses on the interaction between the xApps 20 in the Near-RT RIC 14 and functions who register/manage data in the Non-RT RIC 12. The functions which will register/manage data in the Non-RT RIC 12 can be DME 22 or other entities with different names that serve the same and similar purpose.

As shown in FIG. 3, in order for an xApp 20 in the Near-RT RIC 14 to register the data that it provides to the Non-RT RIC 12, the following steps may be executed:

As shown at step S310, in order to register its generated data, the xApp 20 may invoke a data registration request procedure or any other relevant procedure, or it may send a “data registration request” message or any other relevant messages to the Non-RT RIC 12 via a termination function 16a of the new interface 16 for registering its generated data. The new interface termination functions 16a in the Near-RT-RIC 14 can be A1-related functions that support bi-directional A1-EI to provide analytical data in both directions.

The message sent from the xApps 20 to the new interface termination functions 16a at step S310 may include one or more of the following parameters:
xApp ID (i.e. the xApp's 20 own ID) or the SDL ID (the identifier of the SDL, Storage Definition Languages, file);
Near-RT RIC ID (i.e. the ID of the Near-RT RIC 14 associated to the xApps 20 that provide data);
Analytical data type of the data generated by the xApps 20;
Analytical data reporting Information to indicate the conditions and/or configurations related to collecting the analytical data, such as the intervals of data generation;
Data sources used. This parameter indicates what the data source is that the xApps 20 are using to generate the analytical data. If the registered output data from an xApp 20 is statistical data or inferenced data, this parameter may list the original data sources. This will help that a data consumer has better understanding on the output data;
Output Data Function ID. Examples of Output Data Functions include, but not limited to, raw data, statistical data, inferenced data, etc.; and/or
Methods used. Specifying what methods are used will help a data consumer to have a better understanding on how the output data is generated, e.g., based on what source data. Examples of methods used include, but not limited to, traditional methods, such as linear regression, AI/ML methods, such as deep learning algorithms, combinations of the above, etc.

As will be appreciated by those skilled in the art, different names can be used for the above parameters to serve the same and similar purposes. Furthermore, it is noted that the above parameters may be used in the same or in a similar form in connection with various other embodiments disclosed herein, in particular in connection with a data discovery procedure, a data subscription procedure and a data request procedure as described below.

With respect to the above parameter ‘analytical data type’ it is noted that this parameter generally specifies the type of analytical data (e.g., generated by the xApps), such as UE trajectory prediction, cell coverage prediction, and cell load prediction. As the parameter specifies the data type of the analytical data, it cannot be applied to raw data.

With respect to the above parameter ‘output data function’ it is noted that this parameter generally specifies whether the generated data is raw data, statistical data or inferenced data. Raw data is not analytical data. Statistical data can be analytical data without prediction. Inferenced data is the analytical data with prediction. Each output data function can be assigned an identifier to create an Output Data Function ID (for example, Output Data Function 1=raw data, Output Data Function 2=statistical data, Output Data Function 3=inferenced data).

In a next step, illustrated at S320 in FIG. 3, the new interface termination functions 16a in the Near-RT RIC 14 may invoke a data registration request procedure or any other relevant procedure or send a “data registration request” message or any other relevant message to the related interface termination functions 16b over the new interface 16 between Near-RT RIC 14 and Non-RT RIC 12. As will be appreciated by those skilled in the art, different names can be used for above message to serve the same and similar purposes.

As shown at step S330, the new interface termination functions 16b in the Non-RT RIC 12 may forward the data registration request procedure or any other relevant procedure or send a “data registration request” message or any other relevant message to the functions who register/manage data in the Non-RT RIC 12, which can be DME 22 (as shown in FIG. 3) or any other entity with a different name that serves the same and similar purposes.

The functions who register/manage data in the Non-RT RIC 12, i.e. DME 22 in the exemplary embodiment of FIG. 3, perform data registration of the data provided by the xApps 20, as illustrated at step S340.

After the data registration step and as shown at steps S350, S360 and S370, the functions who register/manage data in the Non-RT RIC 12, i.e. DME 22 in the illustrated embodiment, respond with a “data registration response” message or any other relevant message, which is forwarded via the interface termination functions 16b, 16a of the new interface 16 to the respective xApp 20. As will be appreciated by those skilled in the art, different names can be used for above message to serve the same and similar purposes.

A similar data registration procedure as described above in connection with FIG. 3, can be used by an rApp 18 to register its data in the functions who register/manage data in the Non-RT RIC 12 over the R1 interface 24. The functions who register/manage data in the Non-RT RIC can be DME 22, as shown in FIG. 3, or any other entity with a different name that serves the same and similar purposes.

A respective message for data registration sent from the rApps 18 to the DME 22 may include one or more of the following parameters:
rApp ID (i.e. rApp's 18 own ID);
Analytical data type of the data generated by the rApps 18;
Analytical data reporting Information to indicate the conditions and/or configurations related to reporting the analytical data, such as the intervals of data generation;
Data sources used. This parameter indicates what the data source is that the rApps 18 are using to generate the analytical data. If the registered output data from an rApp 18 is statistical data or inferenced data, this parameter will list the original data sources. This will help that a data consumer has better understanding on the output data.
Output Data Function ID. Examples of Output Data Functions include, but not limited to, raw data, statistical data, inferenced data, etc.; and/or
Methods used. Specifying what methods are used will help a data consumer to have better understanding on how the output data was obtained.

It should be noted again that different names can be used for the above parameters to serve the same and similar purposes.

According to another aspect of the present disclosure, a data discovery procedure may be implemented that allows the rApps 18 in Non-RT RIC 12 to discover the data provided by the Non-RT RIC 12 with new parameters to facilitate intelligent usage of data. A main idea of the data discovery procedure is that an rApp 18 send a data discovery request to functions that register/manage data in the Non-RT RIC 12 to discover the requested data. According to an embodiment, an rApp 18 may discover requested data from DME 22 in Non-RT RIC 12.

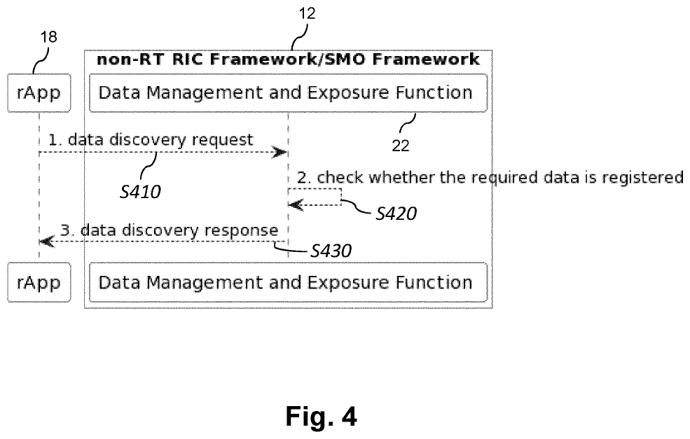

FIG. 4 is a diagram illustrating a data discovery procedure according to an embodiment of the present disclosure. The procedure focuses on the interaction between the rApps 18 in the Non-RT RIC 12 and functions that register/manage data in the Non-RT RIC 12. The functions that register/manage data in the Non-RT RIC can be DME 22 or other entities with different names that serve the same and similar purposes.

As shown in FIG. 4, in order for an rApp 18 in the Non-RT RIC 12 to discover any data that it may require, the following steps may be executed:

As shown at step S410, in order to discover data, an rApp 18 may invoke a data discovery request procedure or any other relevant procedure or send a “data discovery request” message or any other relevant message to the functions who register/manage data in the Non-RT RIC 12, such as DME 22, to discover data.

The message sent from the rApps 18 to the DME 22 at step S410 may include one or more of the following parameters:
rApp ID (i.e. rApp's 18 own ID);
Analytical data type of the data that may be required by the rApp 18;
Analytical data reporting Information to indicate the conditions and/or configurations related to reporting the analytical data;
Data sources used. This parameter indicates what the data source is that the xApps 20 are using to generate the analytical data. If the registered output data from an xApp 20 is statistical data or inferenced data, this parameter will list the original data sources. This will help that a data consumer has better understanding on the output data;
Time interval to collect data;
Output Data Function ID. Examples of Output Data Functions include, but not limited to, raw data, statistical data, inferenced data, etc.; and/or
Methods used. Specifying what methods are used will help a data consumer to have a better understanding on how the output data was obtained. Examples of methods used include, but not limited to, traditional methods, such as linear regression, AI/ML methods, such as deep learning algorithms, combinations of the above, etc.

It should be noted again that different names can be used for the above parameters to serve the same and similar purposes.

In a next step, illustrated at S420 in FIG. 4, the function that registers/manages data in the Non-RT RIC 12, i.e. DME 22 in the illustrated case, checks the registered data and finds the data (provided the data is registered). In addition, the function that registers/manages data in the Non-RT RIC 12 can also provide alternative data sources to the rApps 18, e.g. based on the function's own embedded intelligent data analytical functions. For example, the function (i.e., DME 22 in the illustrated case) may provide alternative analytical data if there is no exact match on the data or provide analytical data if the data is raw data only.

Different names can be used for above messages while serving the same and similar purposes.

As shown at step S430, the functions that register/manage data in the Non-RT RIC 12 (i.e. DME 22 in the illustrated case) respond with a “data discovery response” message or any other relevant message. The response message from the DME 22 to the rApps 18 may include one or more of the following parameters:
rApp ID (i.e. rApp's 18 own ID);
ID(s) of xApps 20 and/or rApps 18 that can produce and/or provide the data;
Application ID of applications that can provide requested analytical data type;
Analytical data reporting Information to indicate the conditions and/or configurations related to reporting the analytical data;
Data sources used. This parameter indicates what the data source is that the xApps 20 or rApps 18 are using to generate the analytical data. If the registered output data from an xApp 20 or an rApp 18 is statistical data or inferenced data, this parameter will list the original data sources. This will help that a data consumer has better understanding on the output data;
Time interval used to collect data;
Output Data Function ID. Examples of Output Data Functions include, but not limited to, raw data, statistical data, inferenced data, etc.; and/or
Methods used. Specifying what methods are used will help a data consumer to have a better understanding on how the output data was obtained. Examples of methods used include, but not limited to, traditional methods, such as linear regression, AI/ML methods, such as deep learning algorithms, combinations of the above, etc.

Different names can be used for above parameters while serving the same and similar purposes.

Obtaining information together with one or more of the above parameters, in particular Data sources, Output Data Function ID, and Methods Used, assists the rApps 18 to improve the data analysis based on data from different data sources and different methods by which the data were obtained, and therefore to use the data efficiently and intelligently.

According to another aspect of the present disclosure, a data subscription procedure may be implemented that allows rApps 18 in Non-RT RIC 12 to subscribe to the data provided by the xApps 20 in the near-RT RIC 14 with new parameters to facilitate intelligent usage of data. A main idea of the data subscription procedure is that an rApp 18 can subscribe to the available analytical data from the application that produces the data. According to an embodiment, an rApp 18 may subscribe to data from DME 22 in Non-RT RIC 12.

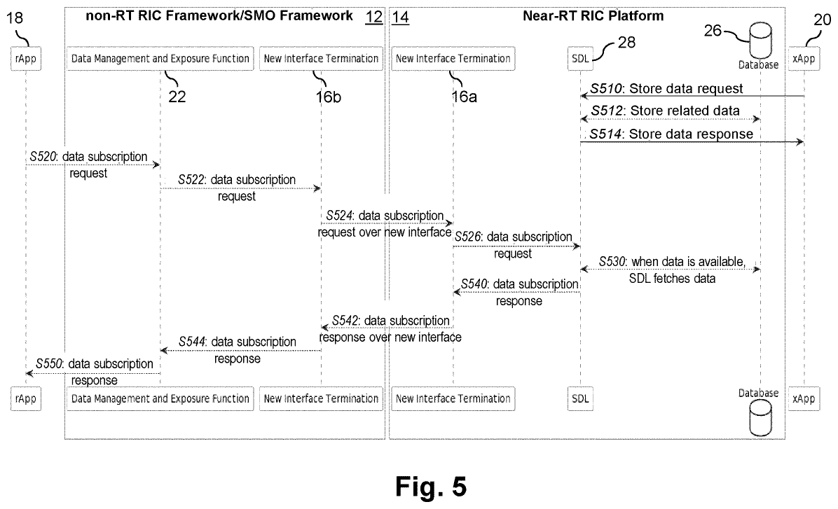

FIG. 5 is a diagram illustrating a data subscription procedure according to an embodiment of the present disclosure. The procedure focuses on the interactions between the rApps 18 in the Non-RT RIC 12 and xApps 20 in the near-RT RIC 14 that produce the analytical data.

As shown in FIG. 5, in order for an rApp 18 in the Non-RT RIC 12 to subscribe to data, the following steps may be executed:

As shown at steps S510, S512 and S514, it may be provided that the xApps 20 store their generated data in a database 26 in the Near-RT RIC 14, e.g. by using a SDL (Storage Definition Languages) based database management system 28.

In order to subscribe the use of data, an rApp 18 executes a data subscription request procedure or any other relevant procedure or sends a “data subscription request” message, as shown at step S520, or any other relevant message to the DME 22. This message sent from the rApps 18 to the DME 22 may include one or more of the following parameters:
rApp ID (i.e. rApp's 18 own ID);
ID(s) of xApps 20 that can produce and/or provide the data;
Analytical data type;
Analytical data reporting Information to indicate the conditions and/or configurations related to reporting the analytical data;
Data sources used. This parameter indicates what the data source is that the xApps 20 are using to generate the analytical data. If the registered output data from an xApp 20 is statistical data or inferenced data, this parameter will list the original data sources. This will help that a data consumer has better understanding on the output data;
Time interval to collect data;
Output Data Function ID. Examples of Output Data Functions include, but not limited to, raw data, statistical data, inferenced data, etc.; and/or
Methods used. Specifying what methods are used will help a data consumer to have a better understanding on how the output data was obtained. Examples of methods used include, but not limited to, traditional methods, such as linear regression, AI/ML methods, such as deep learning algorithms, combinations of the above, etc.

Different names can be used for above parameters while serving the same and similar purposes.

As shown at steps S522, S524 and S526, the DME 22 processes the data subscription request procedure or any other relevant procedure or forwards the “data subscription request” message or any other relevant message to the functions that manage the data in Near-RT RIC 14 to collect the data. According to the illustrated embodiment, the respective messages are relayed via interface terminal functions 16b, 16a over the new interface 16 described in detail above.

The functions that manage the data in Near-RT RIC 14 can be the SDL based database management system 28 or any other entity that provides the same or similar functions.

The “data subscription request” message sent from the DME 22 to the SDL based database management system 28 may include one or more of the parameters specified above. According to a preferred embodiment, the “data subscription request” message sent from the DME 22 to the SDL based database management system 28 may include exactly the same parameters as the message sent from the rApps 18 to the DME 22 (cf. step S500).

As shown at step S530, the functions that manage the data in Near-RT RIC 14 fetch the data when it is available or updated. Specifically, as shown in FIG. 5, when the data is available, database management system 28 may fetch the data from database 26.

At steps S540, S542 and S544, the functions that manage the data in Near-RT RIC 14 respond with a “data subscription response” message or any other relevant message. This message sent from the SDL based database management system 28 to the DME 22 may include one or more of the following parameters:
rApp ID (i.e. rApp's 18 own ID);
xApp IDs of the xApps 20 that can produce and/or provide the data;
Analytical data type;
Analytical data reporting Information to indicate the conditions and/or configuration related to reporting Analytics data;
Data sources used. This parameter indicates what the data source is that the xApps 20 are using to generate the analytical data. If the registered output data from an xApp 20 is statistical data or inferenced data, this parameter will list the original data sources. This will help that a data consumer has better understanding on the output data;
Time interval used to collect the requested data;
Output Data Function ID. Examples of Output Data Functions include, but not limited to, raw data, statistical data, inferenced data, etc.;
Methods used. Specifying what methods are used will help a data consumer to have a better understanding on how the output data was obtained. Examples of methods used include, but not limited to, traditional methods, such as linear regression, AI/ML methods, such as deep learning algorithms, combinations of the above, etc.;
The location of the data; and/or
The methods of data delivery.

As shown at step S550, the DME 22 responds to the rApps 18 with “data subscription response” message or any other relevant message.

Obtaining information regarding the above-mentioned parameters, in particular information on Data sources used and Methods Used, assists the rApps 18 to improve the data analysis based on data from different data sources and different methods by which the data were obtained, and therefore to use the data efficiently and intelligently.

A similar data subscription procedure as described above can be used by the rApps 18 to subscribe the data they produce/provide at the functions that register/manage data in the Non-RT RIC 12 over the R1 interface 24. The functions that register/manage data in the Non-RT RIC 12 can be DME 22 or any entity with other names that serve the same and similar purposes. The respective message sent from the rApps 18 to the DME 22 may include one or more of the following parameters:
rApp ID (i.e. rApp's 18 own ID);
rApp IDs of the rApps 18 that can produce and/or provide the data;
Analytical data type of the data that the rApp 18 generates;
Analytical data reporting Information to indicate the conditions and/or configurations related to reporting the analytical data, such as the interval of data generation;
Data sources used. This parameter indicates what the sources are that the rApps 18 are using to generate the analytical data. If the registered output data from an rApp 18 is statistical data or inferenced data, this parameter will list the original data sources. This will help that a data consumer has better understanding on the output data;
Time interval to collect data;
Output Data Function ID;
Methods used. This will help that a data consumer has better understanding on how the output data was obtained.

Different names can be used for above parameters while serving the same and similar purposes.

According to another aspect of the present disclosure, a data request procedure may be implemented that allows rApps 18 in the Non-RT RIC 12 to get the data provided by the xApps 20 in the near-RT RIC 14 with new parameters to facilitate intelligent usage of data (rApps->DME in Non-RT RIC). A main idea of the data request procedure is to enable the rApps 18 to request one-time analytical data from the applications that produce the requested data. According to an embodiment, an rApp18 may request data from DME 22 in Non-RT RIC 12.

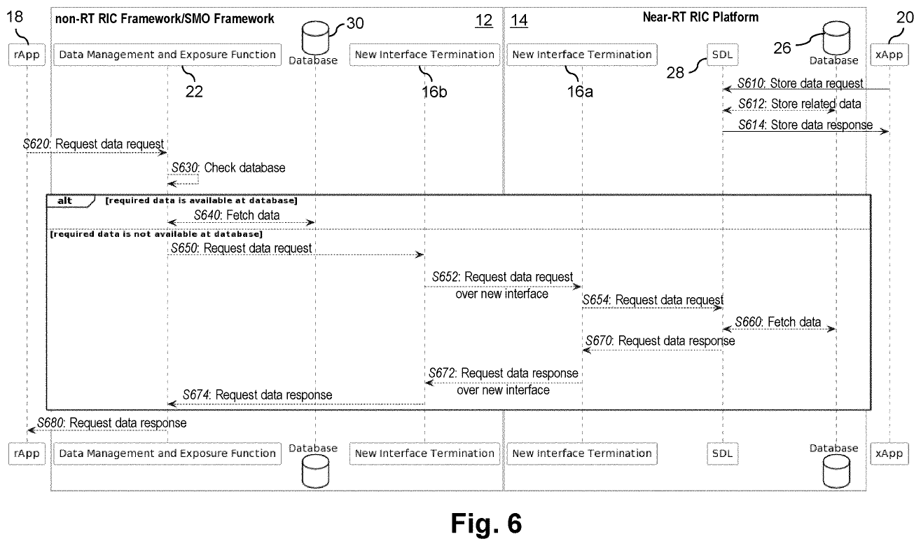

FIG. 6 is a diagram illustrating a data request procedure for rApps 18 in the Non-RT RIC 12 to obtain data according to an embodiment of the present disclosure. The procedure focuses on the interaction between the rApps 18 in the Non-RT RIC 12 and the xApps 20 in the near-RT RIC 14 that produce the analytical data.

As shown in FIG. 6, in order for an rApp 18 in the Non-RT RIC 12 to get/obtain data, the following steps may be executed:

As shown at steps S610, S612 and S614, it is again assumed that the xApps 20 store their generated data in a database 26 in the Near-RT RIC 14, e.g. by using a SDL (Storage Definition Languages) based database management system 28.

In order to request data, it may be provided that an rApp 18 invokes a request data request procedure or any other relevant procedure or sends a “request data request” message, as shown at step S620, or any other relevant message to the DME 22 to collect the data. This message from the rApps 18 to the xApp 20 may include one or more of the following parameters:
rApp ID (i.e. rApp's 18 own ID);
ID(s) of xApps 20 that can generate and/or provide the data;
Analytical data type;
Analytical data reporting Information to indicate the conditions and/or configurations related to reporting the analytical data;
Data sources used. This parameter indicates what the source is that the xApps 20 are using to generate the analytical data. If the registered output data from an xApp 20 is statistical data or inferenced data, this parameter will list the original data sources, which will help that a data consumer has better understanding on the output data;
Time interval to collect data;
Output Data Function ID. Examples of Output Data Functions include, but not limited to, raw data, statistical data, inferenced data, etc.; and/or
Methods used. Specifying what methods are used will help a data consumer to have a better understanding on how the output data was obtained. Examples of methods used include, but not limited to, traditional methods, such as linear regression, AI/ML methods, such as deep learning algorithms, combinations of the above, etc.

Different names can be used for the above parameters and messages while serving the same and similar purposes.

Next, as shown at step S630, the DME 22 (or any other function that registers/manages data in the Non-RT RIC 12) checks whether the data is stored in the database 30 inside the Non-RT RIC 12.

If the data is stored in the database 30 in Non-RT RIC 12, the procedure proceeds to step S640, i.e. the DME 22 fetches the data from the database 30 in Non-RT RIC 12.

On the other hand, if the data is not stored in the database 30 in Non-RT RIC 12, the procedure proceeds to steps S650, S652 and S654. Accordingly, the DME 22 invokes a request data request procedure or any other relevant procedure or sends a “request data request” message or any other relevant message to the functions that manage the data in Near-RT RIC 14 to collect the data. Specifically, as shown at step S650, S652 and S654, the message is forwarded via interface terminal functions 16b, 16a over the new interface 16 (cf. FIG. 2). The functions that manage the data in Near-RT RIC 14 can be SDL based database management system 28 (as shown in FIG. 6) or any other entity that provides the same or similar functions.

The message sent from the DME 22 to the SDL 28 may include one or more of the following parameters:
rApp ID (i.e. rApp's 18 own ID);
ID(s) of xApps 20 that can generate and/or provide the data;
Analytical data type;
Analytical data reporting Information to indicate the conditions and/or configurations related to reporting the analytical data;
Data sources used. This parameter indicates what the source is that the xApps 20 are using to generate the analytical data. If the registered output data from an xApp 20 is statistical data or inferenced data, this parameter will list the original data sources, which will help that a data consumer has better understanding on the output data;
Time interval to collect data;
Output Data Function ID. Examples of Output Data Functions include, but not limited to, raw data, statistical data, inferenced data, etc.; and/or
Methods used. Specifying what methods are used will help a data consumer to have a better understanding on how the output data was obtained. Examples of methods used include, but not limited to, traditional methods, such as linear regression, AI/ML methods, such as deep learning algorithms, combinations of the above, etc.

Different names can be used for the above parameters to serve the same and similar purposes.

As shown at step S660, the SDL database management system 28 (or any other function that manages the data in Near-RT RIC 14) fetches the data when it is available at the database 26 of the data in Near-RT RIC 14.

Next, as shown at step S670, the SDL database management system 28 (or any other function that manages the data in Near-RT RIC 14) responds with a “request data response” message or any other relevant message. This message is forwarded via the interface termination functions 16a, 16b of the new interface 16 (as illustrated in FIG. 2) to the DME 22 (or any other function that manages the data in Non-RT RIC 12), as shown at steps S672 and S674. The message sent from the SDL 28 to the DME 22 may include one or more of the following parameters:
rApp ID (i.e. rApp's 18 own ID);
ID(s) of xApps 20 that can generate and/or provide the data;
Analytical data type;
Analytical data reporting Information to indicate the conditions and/or configurations related to reporting the analytical data;
Data sources used. This parameter indicates what the source is that the xApps 20 are using to generate the analytical data. If the registered output data from an xApp 20 is statistical data or inferenced data, this parameter will list the original data sources, which will help that a data consumer has better understanding on the output data;
Time interval used to collect data;
Output Data Function ID. Examples of Output Data Functions include, but not limited to, raw data, statistical data, inferenced data, etc.; and/or
Methods used. Specifying what methods are used will help a data consumer to have a better understanding on how the output data was obtained. Examples of methods used include, but not limited to, traditional methods, such as linear regression, AI/ML methods, such as deep learning algorithms, combinations of the above, etc.
The location of the data; and/or
The methods used for data delivery.

As shown at step S680, the DME 22 responds to the rApps 18 with a “request data response” message or any other relevant message.

Obtaining information together with one or more of the above parameters, in particular on the Data Sources Used and on the Methods Used, assists the rApps 18 to undertake improved data analysis based on data from different data sources and different methods by which the data were obtained, and therefore to use the data efficiently and intelligently.

A similar data request procedure as described above in connection with FIG. 6, can be used by an rApp 18 to request its data at the end functions who register/manage data in the Non-RT RIC 12 over the R1 interface 24. The functions who register/manage data in the Non-RT RIC can be DME 22, as shown in FIG. 6, or any other entity with a different name that serves the same and similar purposes.

A respective message for data request sent from the rApps 18 to the DME 22 may include one or more of the following parameters:
rApp ID (i.e. rApp's 18 own ID);
ID(s) of rApps 18 that can generate and/or provide the data;
Analytical data type that the rApp 18 generated;
Analytical data reporting Information to indicate the conditions and/or configurations related to reporting the analytical data, such as the interval of data generation;
Data sources used. This parameter indicates what the source is that the rApps 18 used or are using to generate the analytical data. If the registered output data from a rApp is statistical data or inferenced data, this parameter will list the original data sources, which will help that a data consumer has better understanding on the output data;
Output Data Function ID; and/or
Methods used. This parameter will help a data consumer to have a better understanding on how the output data was obtained.

Different names can be used for the above parameters while serving the same and similar purposes.

According to embodiments of the present disclosure, the new parameters provided herein, such as Data sources used, Output Data Function ID and Methods Used, are provided by the Non-RT RIC 12 to the Near-RT RIC 14 via the new or extended A1-EI interfaces 16 as well. They are used in the data registration, data discovery, data subscription and data request related procedures/messages. In this way, the xApps 20 can improve the data analysis based on data from different data sources and different methods, and can therefore use the data efficiently and intelligently.

### System Overview

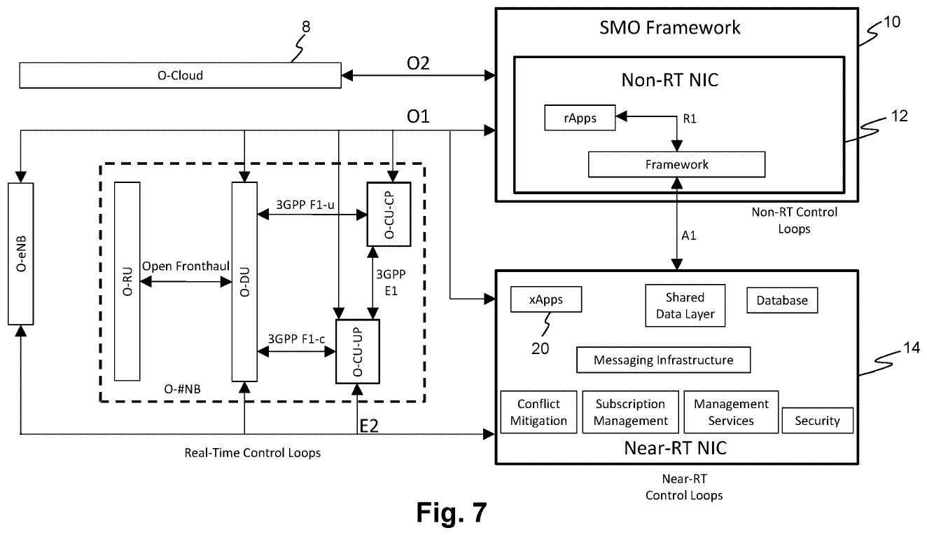

FIG. 7 schematically illustrates an O-RAN architecture to which the above aspects are applicable.

This architecture comprises the functional components: Non-RT RIC 12 and the near-RT RIC 14. While the former is hosted by the SMO framework 10 of the system (e.g., integrated within ONAP), the latter may be co-located with 3GPP gNB functions (O-CU and/or O-DU) or in a separate node as long as latency constraints are respected. FIG. 7 also depicts the O-Cloud 8, an O-RAN compliant cloud platform that uses hardware acceleration addons when needed and a software stack that is decoupled from the hardware to deploy eNBs/gNBs as virtualized network functions in v(R)AN scenarios.

The SMO 10 has various organisation and management services, which may go beyond pure RAN management, such as 3GPP (NG-)core management or end-to-end network slice management. In the context of O-RAN, the main responsibilities of the SMO 10 include: fault, configuration, accounting, performance, and security (FCAPS) interface to O-RAN network functions; large-timescale RAN optimization; and O-Cloud management and orchestration via the O2 interface, including resource discovery, scaling, FCAPS, software management, and interacting with O-Cloud resources.

The Non-RT RIC 12 is a logical function that enables non-real-time control and optimization of RAN elements and resources, AI/ML workflow including model training and updates, and policy-based guidance of applications/features in near-RT RIC 14. The Non-RT RIC 12 also provides the A1 interface to the Near-RT RIC 14. Its main goal is to support large timescale RAN optimization (seconds or minutes), including policy computation, ML model management, and other radio resource management functions within this timescale. Data management tasks requested by the Non-RT RIC 12 should be converted into the O1/O2 interface; and contextual/enrichment information can be provided to the Near-RT RIC 14 via the A1 interface.

The Near-RT RIC 14 is a logical function that enables near-real-time optimization and control and data monitoring of O-CU and O-DU nodes and resources in near-RT timescales (between 10 ms and 1 s) via fine-grained data collection and actions over the E2 interface. Near-RT RIC 14 control is steered by the policies and assisted by models computed/trained by the non-RT RIC 12. Near-RT RIC 14 also supports xApps 20 (independent software plug-ins to the Near-RT RIC 14 platform to provide functional extensibility to the RAN by third parties).

This architecture inherently provides three independent control loops:
Non-RT RIC 12 control loop: Large-timescale operation on the order of seconds or minutes. The goal is to perform O-RAN-specific orchestration decisions such as policy configuration or ML model training.
Near-RT RIC 14 control loop: Sub-second time-scale operation. The goal is performing tasks such as policy enforcement or radio resource management operations.
O-DU scheduler control loop: Real-time operation performing legacy radio operations such as HARQ, beamforming, or scheduling.

It will be appreciated that whilst the control loops are understood to be independent, they may still interact with each other.

The components of this architecture are configured to perform one or more of the above described solutions.

### User Equipment (UE)

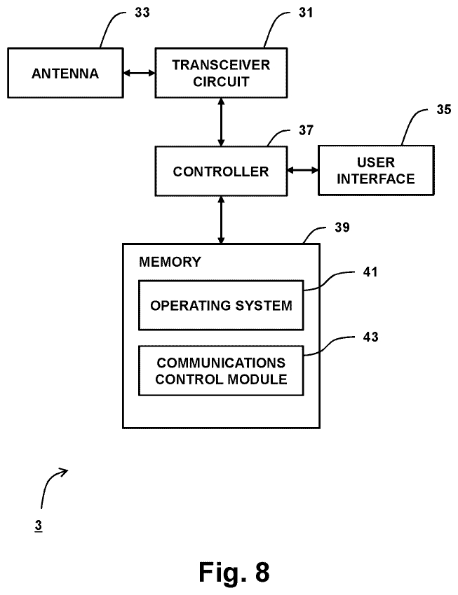

FIG. 8 is a block diagram illustrating the main components of a UE (mobile device 3) that communicates with the system shown in FIG. 7. As shown, the UE 3 includes a transceiver circuit 31 which is operable to transmit signals to and to receive signals from the connected node(s) via one or more antenna 33. Although not necessarily shown in FIG. 8, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via a telecommunication network or from a removable data storage device (RMD), for example. The software includes, among other things, an operating system 41 and a communications control module 43. The communications control module 43 is responsible for handling (generating/sending/receiving) signalling messages and uplink/downlink data packets between the UE 3 and other nodes, including v(R)AN nodes 5, application functions, and core network nodes. Such signalling includes appropriately formatted requests and responses relating to AI&ML model training, verification, registration and deployment.

### Virtual Ran (V(R)AN) Node

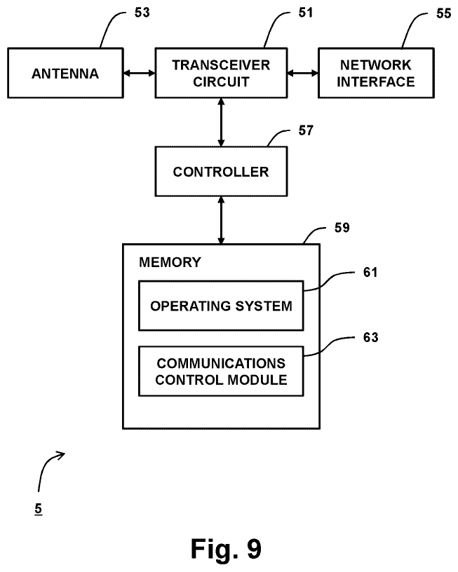

FIG. 9 is a block diagram illustrating the main virtual components of an exemplary v(R)AN node 5 (base station) that can be used in the system shown in FIG. 7. As shown, the v(R)AN node 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station—base station interface (such as X2/Xn) and an appropriate base station—core network interface (such as NG-U/NG-C). A controller 57 controls the operation of the v(R)AN node 5 in accordance with software stored in a memory 59. The software may be pre-installed in the memory 59 and/or may be downloaded via a telecommunication network or from a removable data storage device (RMD), for example. The software includes, among other things, an operating system 61 and a communications control module 63. The communications control module 63 is responsible for handling (generating/sending/receiving) signalling between the v(R)AN node 5 and other nodes, such as the UE 3, and the core network nodes.

### Core Network Node

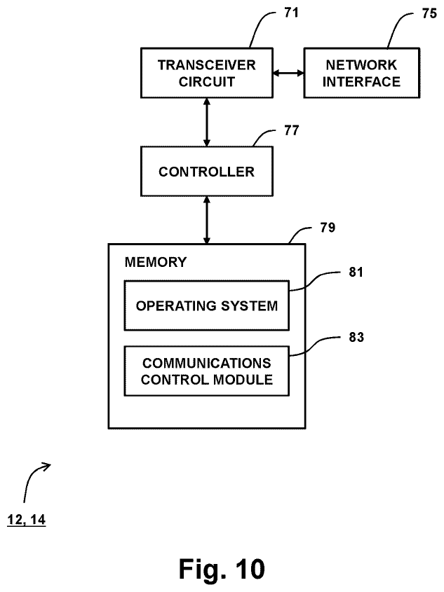

FIG. 10 is a block diagram illustrating the main virtual components of a generic core network node (or function) that can be used in the system shown in FIG. 7. As shown, the core network node includes a transceiver circuit 71 which is operable to transmit signals to and to receive signals from other nodes (including the UE 3 and the v(R)AN node 5) via a network interface 75. A controller 77 controls the operation of the core network node in accordance with software stored in a memory 79. The software may be pre-installed in the memory 79 and/or may be downloaded via a telecommunication network or from a removable data storage device (RMD), for example. The software includes, among other things, an operating system 81 and at least a communications control module 83. The communications control module 83 is responsible for handling (generating/sending/receiving) signalling between the core network node and other nodes, such as the UE 3, v(R)AN node 5, and other core network nodes. Such signalling includes appropriately formatted requests and responses relating to Intelligent Data Collection and Management for Open RAN Intelligent Controllers.

### Modifications and Alternatives

Detailed aspects have been described above. As those skilled in the art will appreciate, a number of modifications and alternatives can be made to the above aspects whilst still benefiting from the inventions embodied therein. By way of illustration, only a number of these alternatives and modifications will now be described.

In the above description, the UE, the v(R)AN node, and the core network node are described for ease of understanding as having a number of discrete modules (such as the communication control modules). Whilst these modules may be provided in this way for certain applications, for example where an existing system has been modified to implement the above aspects, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE, the (R)AN node, and the core network node as a signal over a computer network, or on a recording medium. Further, the functionality performed by part or all of this software may be performed using one or more dedicated hardware circuits. However, the use of software modules is preferred as it facilitates the updating of the UE, the (R)AN node, and the core network node in order to update their functionalities.

The above aspects are also applicable to ‘non-mobile’ or generally stationary user equipment.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method of operating an open radio access network (O-RAN), the O-RAN comprising a Non-Real-Time RAN Intelligent Controller (Non-RT RIC), and a Near-Real-Time RAN Intelligent Controller (Near-RT RIC), the method comprising:
providing an interface between the Non-RT RIC and the Near-RT RIC; and
using the interface to send analytical data from the Near-RT RIC to the Non-RT RIC.

2. The method according to claim 1, further comprising:
executing, via the interface, a data registration procedure, in which an xApp in the Near-RT RIC registers data, which the xApp generates and/or provides, at the Non-RT RIC.

3. The method according to claim 2, wherein the data registration procedure comprises sending, by the xApp, a data registration request to a function that registers and/or manages data in the Non-RT RIC.

4. The method according to claim 3, wherein the data registration request comprises one or more parameters specifying characteristics of the data to be registered, the one or more parameters including at least one of an indication of an ID of the xApp requesting data registration, an ID of the Near-RT RIC, an ID of a storage definition language (SDL) that manages the data to be registered, data sources and/or methods used to generate the data to be registered, an analytical data type of the data to be registered, an indication of the conditions and/or configurations related to the generation of the data to be registered, and an output data function ID of the data to be registered.

5. The method according to claim 1, further comprising:
executing, via the interface, a data discovery procedure, in which an rApp in the Non-RT RIC discovers data that xApps in the Non-RT RIC generate and/or provide.

6. The method according to claim 5, wherein the data discovery procedure comprises sending, by the rApp, a data discovery request related to analytical data, to a function that registers and/or manages data in the Non-RT RIC,
wherein the function that registers and/or manages data in the Non-RT RIC, upon receipt of the data discovery request, checks whether the analytical data is registered.

7. The method according to claim 6, wherein the function that registers and/or manages data, in case the analytical data to which the data discovery request relates is found to be not registered, provides alternative data sources and/or alternative analytical data.

8. The method according to claim 1, further comprising:
executing, via the interface, a data subscription procedure, in which an rApp in the Non-RT RIC subscribes to data generated and/or provided by an xApp in the Near-RT RIC.

9. The method according to claim 8, wherein the data subscription procedure includes sending, by the rApp, a data subscription message related to required analytical data to a function that registers and/or manages data in the Non-RT RIC,
wherein the function that registers and/or manages data in the Non-RT RIC requests data via the interface from the Near-RT RIC, and
wherein the Near-RT RIC, via the interface, provides the requested data or responds with information on how to obtain the requested data.

10. The method according to claim 1, further comprising:
executing, via the interface, a data request procedure, in which an rApp in the Non-RT RIC requests data generated and/or provided by xApps in the Near-RT RIC.

11. The method according to claim 10, wherein the data request procedure includes sending, by the rApp, a data request message related to analytical data to a function that registers and/or manages data in the Non-RT RIC,
wherein the function that registers and/or manages data in the Non-RT RIC requests the requested data via the interface from the Near-RT RIC, and
wherein the Near-RT RIC, via the interface, provides the requested data or responds with information on how to obtain the requested data.

12. An open radio access network (O-RAN) system the O-RAN system comprising:
a Non-Real-Time RAN Intelligent Controller (Non-RT RIC);
a Near-Real-Time RAN Intelligent Controller (Near-RT RIC); and
an interface between the Non-RT RIC and the Near-RT RIC, wherein the interface is configured to enable sending analytical data from the Near-RT RIC to the Non-RT RIC.

13. The system according to claim 12, wherein the interface is a bidirectional extension of an O-RAN A1-EI interface implemented between the Non-RT RIC and the Near-RT RIC.

14. The system according to claim 13, wherein the interface is implemented between the Non-RT RIC and the Near-RT RIC as an additional interface separate from the O-RAN A1-EI interface, wherein the interface is configured to enable sending analytical data from the Near-RT RIC to the Non-RT RIC.

15. The system according to claim 12, wherein the interface is configured to enable an exchange of messages between the Non-RT RIC and the Near-RT RIC, wherein the messages relate to at least one of a data registration procedure, a data discovery procedure, a data subscription procedure, and a data request procedure.

16. The system according to claim 12, wherein the interface is configured to enable an exchange of messages between the Non-RT RIC and the Near-RT RIC, wherein the messages are enriched by one or more parameters specifying characteristics of the data addressed by the respective messages, the one or more parameters including at least one of an ID of the xApp requesting data registration, an ID of the Near-RT RIC, an ID of a storage definition language (SDL) that manages the data to be registered an indication of data sources and/or methods used to generate the data, an analytical data type of the data, an indication of the conditions and/or configurations related to the generation of the data, and an output data function ID of the data.
